(19) United States
(12) Patent Application Publication
(10) Pub. No.: US 2025/0102432 A1
(43) Pub. Date: Mar. 27, 2025

(54) OPTICAL INSPECTION OF PULP BOTTLES

(71) Applicant: Krones AG, Neutraubling (DE)

(72) Inventors: Rainer KWIRANDT, Barbing (DE); Anton NIEDERMEIER, Offenstetten (DE); Stefan PIANA, Köfering (DE); Peter LINDNER, Langquaid (DE)

(21) Appl. No.: 18/891,680

(22) Filed: Sep. 20, 2024

(30) Foreign Application Priority Data
Sep. 21, 2023 (DE) 102023125598.3

(51) Int. Cl. G01N 21/51; G01N 21/17; G01N 21/88

(52) U.S. Cl. CPC G01N 21/51; G01N 21/8806; G01N 2021/177; G01N 2201/068

(57) ABSTRACT

The present disclosure relates to an apparatus for optically inspecting a pulp bottle. The apparatus comprises a lighting device having an opening, wherein a mouth of the pulp bottle can be arranged below the opening of the lighting device; and a camera which is configured to take an image of at least a part of an inner wall of the pulp bottle through the opening of the lighting device or from the opening of the lighting device, wherein the pulp bottle can be arranged such that the part of the inner wall of the pulp bottle is illuminated by the lighting device. The present disclosure further provides a method for optically inspecting a pulp container, in particular a pulp bottle.

### CROSS REFERENCE TO RELATED APPLICATION

The present application claims priority to German Patent Application No. 10 202 125 598.3 filed on Sep. 21, 2023. The entire contents of the above-listed application are hereby incorporated by reference for all purposes.

### TECHNICAL FIELD

The present disclosure relates to an apparatus and to a method for optically inspecting pulp bottles, in particular the inner wall thereof.

### BACKGROUND

Before containers, such as beverage bottles and cans, can be used for filling, it must be ensured that they do not have any damage, such as cracks or holes, and that they are not contaminated. To this end, transparent containers can be checked for contamination, foreign bodies or damage from the outside using transmitted light. For opaque cans, there are inner-wall inspections in which light from a large-surface-area light source is emitted through the large can mouth, which is approximately the same diameter as the can. Apparatuses for the optical inspection of containers, in particular beverage cans, are known, for example, from DE 199 40 363 A1 and DE 10 2017 123 684 A1.

### SUMMARY

Pulp containers, however, are made of diffuse, opaque material, which means that the interior cannot be easily inspected from the outside. In addition, pulp bottles in particular have a thin bottle neck compared to cans, making it difficult for light to reach the interior and thus illuminate the inner wall of the bottle.

Therefore, it is an object of the present disclosure to provide an apparatus and a method which allow reliable inspection of pulp bottles for contamination or damage. For this purpose, the disclosure provides an apparatus and a method.

According to the disclosure, the apparatus for optically inspecting a pulp bottle comprises a lighting device having an opening, wherein a mouth of the pulp bottle can be arranged below the opening of the lighting device; and a camera which is configured to take an image of at least a part of an inner wall of the pulp bottle through the opening of the lighting device or from the opening of the lighting device, wherein the pulp bottle can be arranged such that the part of the inner wall of the pulp bottle is illuminated by the lighting device.

Unlike metal cans, for example, pulp does not reflect the incoming light, but merely scatters it diffusely or absorbs part of it. In addition, cans typically have a larger mouth diameter than bottles, making it comparatively easy to introduce light into the interior of a can. In order to adequately illuminate the inner wall of the pulp bottle for a visual inspection for damage and/or contamination, sufficient light must now be coupled into the interior of the pulp bottle through the mouth and the bottle neck and the light scattered inside must be captured by a camera. This object is achieved by the claimed configuration of a lighting device and a camera with respect to a pulp bottle located underneath.

The pulp bottle can consist entirely or predominantly of a mixture of water, fibers and possibly other additives, this mixture being known as pulp. The fibers can be of natural origin and biodegradable. The fibers may comprise lignin, banana leaves and/or wild quinine. The fibers may, for example, comprise cellulose fibers, fibers of conifers, of leafy woody plants and/or plane trees and/or grasses, reeds and/or bamboo or the like. The fibers may comprise silk threads, spider silk, algae, natural fibers (such as cup-plant fibers, hemp, maize, cotton), banana peel, orange peel, grass, straw, potato starch or processed cow dung. It is also possible to provide cellulose fibers which originate from a process by which they were artificially grown. In the event of material bottlenecks of wood as the basic material for a fluid mass with fibers, these alternative materials can completely or partially replace the basic material. The fibers can likewise comprise fiber mixtures made of non-wood material, for example cotton, hemp and/or textile fibers.

An inner wall of the pulp bottle refers to the entire area which delimits the interior or the inside of the pulp bottle. These include, for example, the bottle bottom, the shell and/or the bottle neck. Incident light is scattered by this surface and impinges on the camera through the mouth of the pulp bottle.

Typically, the diameter of the opening of the pulp bottles is not more than 5 cm, in particular not more than 3 cm. A pulp bottle may further be characterized by the fact that its diameter increases from the mouth towards the bottom and that its height is greater than the diameter of the mouth and/or greater than the diameter of the bottom.

The lighting device can comprise one light source or a plurality of light sources. Furthermore, the lighting device can be ring-shaped or ring-like. In this context, ring-shaped means that the part of the lighting device surrounding the opening can be triangular, rectangular, otherwise polygonal or even irregularly shaped. Likewise, said part of the lighting device can only surround a portion of the opening. A ring-shaped lighting device comprises in particular a circular or elliptical environment of the opening. In particular, the center of the lighting device is arranged so that the mouth of the pulp bottle is located vertically below the center. This configuration achieves a particularly uniform illumination of the inner wall of the pulp bottle, which makes reliable inspection possible.

A spectrum of the lighting device can be in the visible range of the electromagnetic spectrum (400 nm to 800 nm). However, it can be advantageous to use ultraviolet light, for example between 200 nm and 400 nm, to induce fluorescence in the pulp, causing the pulp bottle itself to glow. This allows a higher contrast to be achieved between the pulp and the contamination in the event of contamination, making it easier to identify contaminated pulp bottles. Instead, infrared light, for example between 800 nm and 1500 nm, can be used. This facilitates the identification of holes or cracks in the inner wall of the pulp bottle because a higher contrast is achieved between the pulp and a metal mold surrounding the pulp bottle.

The camera can comprise a lens and an imaging chip, wherein the lens focuses the scattered light passing through the mouth of the pulp bottle and images it onto the imaging chip.

The apparatus can also comprise a further lens arranged between the mouth of the pulp bottle and the camera. The further lens can, for example, be what is known as an inner wall lens. In addition, the lens can have a large depth of field in order to be able to sharply image the largest possible region between the bottle neck and the bottle bottom.

Optionally, the lens has a doubly crossed beam path, wherein the highly tapered beam path extending from the lens, or the focal point thereof, is located in the region of the mouth bead. This ensures that despite any shifting of the pulp bottles during transport, the beam path remains clear and is not obscured by the container mouth.

The camera can be arranged in the opening of the lighting device.

Firstly, the arrangement of the camera in the opening of the lighting device can represent a compact design, so that the camera and the lighting device can also be arranged at a short distance from the mouth of the pulp bottle. In particular, the lighting device is ring-shaped or ring-like, the light can be radiated symmetrically into the pulp bottle, resulting in uniform illumination of the inner wall of the pulp bottle.

The lighting device can be arranged such that light from the lighting device is irradiated at an angle between 60° and 90°, in particular between 70° and 90°, relative to a mouth plane of the pulp bottle.

The specification of the angle is based on beam optical assumptions. The closer the angle is to 90°, the better the light is radiated through the bottle neck into the interior of the pulp bottle. An angle that is as large as possible (less than or equal to) 90° therefore ensures good illumination and reliable optical detection of damage and/or dirt. If the angle is too small, the light cannot penetrate deep enough into the pulp bottle and parts of the inner wall, in particular the bottom, are not sufficiently illuminated. This reduces the reliability of the inspection because damage and/or contamination cannot be detected due to poor lighting and thus low contrast.

The apparatus described can further comprise an anti-reflective protective window, wherein the lighting device and the camera are arranged on the side of the protective window facing away from the pulp bottle and wherein the camera is not in direct contact with the protective window.

The protective window shields the lighting device and the camera from any contamination and allows for reliable optical inspection. Avoiding direct contact between the camera and the protective window also ensures that the camera is not damaged by impacts. The anti-reflective protective window, for example, has an anti-reflective coating which has a low reflection for the wavelength range of the light used, for example in the range of one percent or less. This reduces artifacts caused by reflections which could lead to false identification of dirt or cracks in the pulp bottle.

A protective element made of elastic, opaque material, such as foam rubber, can be arranged between the camera and the protective window.

In this case, the element serves two purposes. On the one hand, its elastic properties absorb shocks and thus protect the camera arranged behind the protective window from damage caused by impacts. On the other hand, the opaque element prevents light from the lighting device from shining directly into the camera, which would lead to distortion and contrast degradation of the captured images and thus reduce the reliability of the inspection.

The lighting device can comprise a plurality of light sources, such as chip-on-board LEDs (COB LEDs). In the case of a ring-shaped or ring-like lighting device in which the camera is arranged in the opening of the lighting device, the LEDs can in particular be arranged around the camera (the lens).

With COB LEDs it is possible to arrange a plurality of individual LED chips close together in a small area. This allows a high power density to be achieved and a high light output to be radiated into the interior of the pulp bottle. With the described ring-shaped or ring-like lighting device, a high light output can be radiated into the pulp bottle, in particular all around, in order to achieve uniform illumination of the inner wall. The images taken in this way have a high contrast and the detection of damage and/or contamination is particularly reliable.

An example is a ring-shaped lighting device having a diameter of 14 mm. 130 LED chips can be located thereon, which are operated with 130 watt pulses.

The LEDs can be arranged directly on the protective window. This results in a compact design because no separate element is required for installing the LEDs.

The apparatus can further comprise a beam splitter and a light source. The beam splitter can be arranged between the mouth of the pulp bottle and the camera. The light source can be configured as a homogeneous surface illumination and can be at least partially faded in by the beam splitter through the mouth into the interior of the pulp bottle. Optionally, an optical element can be arranged between the beam splitter and the light source. The optical element can comprise a lens element and/or polarization filter.

Alternatively to the configuration described above, the device can further comprise a beam splitter and a pattern projector. The beam splitter can be arranged between the mouth of the pulp bottle and the camera and the pattern projector can be configured to generate an optical pattern and arranged such that the pattern generated by the pattern projector is partially reflected by the beam splitter through the mouth into the interior of the pulp bottle.

While the previously described illumination of the inner wall of the pulp bottle, which is as uniform as possible, is aimed at detecting damage and/or contamination, the optical pattern can be used to detect whether there are material distribution errors. Irregularities in the wall thickness of the pulp bottle lead to a distortion of the optical pattern (compared to a flat surface), which can be detected in an image taken by the camera.

The beam splitter can be a 50:50 beam splitter, which reflects about 50% of the incident radiation/output and transmits the remaining part. However, other beam splitters having a different reflection fraction (25% or 40%) are also conceivable.

If the apparatus comprises a further lens, this is arranged in particular between the beam splitter and the mouth of the pulp bottle. This means that the further lens can be used both to couple the optical pattern into the pulp bottle and to focus the light scattered from the pulp bottle.

The pattern generated by the pattern projector can be grid-shaped and/or it can comprise concentric circles.

The two types of patterns mentioned allow the clearest possible identification of material distribution errors. If the pulp bottle has an irregular wall thickness due to material distribution errors, the optical pattern will be distorted at places with different wall thicknesses. The distortion, which is a deviation from a regular pattern of a grid or concentric circles, can be evaluated in the image captured by the camera. Deviations from straight lines (in a grid) or circles can be detected particularly reliably.

The disclosure further provides a system comprising an apparatus for producing pulp bottles and the described apparatus for optically inspecting a pulp bottle. The system is configured such that the pulp bottles are transported to the apparatus for optical inspection after production.

A method according to the disclosure for optically inspecting a pulp container, in particular a pulp bottle, comprises illuminating a part of an inner wall of the pulp container through its mouth with a lighting device, and taking an image through the mouth of the pulp container with a camera by capturing the light scattered from the interior of the pulp container using the camera.

The method solves the technical problem mentioned above of achieving a reliable inspection of pulp containers, such as pulp bottles, for damage and/or contamination.

The light from the lighting device can be irradiated at an angle between 60° and 90°, in particular between 70° and 90°, relative to a mouth plane of the pulp bottle. As already explained in connection with the apparatus, the specified angle ranges allow for reliable inspection.

The method can further comprise illuminating a portion of an inner wall of the pulp container with an optical pattern generated, for example, by a pattern projector, and taking a further image by capturing the light scattered from the interior of the pulp container using the camera.

With this method, in which the two images are evaluated, a pulp container can be examined for damage and/or contamination, as well as for irregular material distribution. This results in a more comprehensive characterization and a more reliable inspection of the pulp container.

The order of the two images can be arbitrary. It is also possible to take the image with the optical pattern first and then the image with the most uniform illumination possible (i.e. without a pattern) or vice versa.

The pattern used can be grid-like and/or comprise concentric circles. Reference is made to the previously mentioned advantages of these particular patterns.

The time interval between the taking of the (first) image and the subsequent image can be less than 100 μs, in particular less than 50 μs.

Typically, the described method is implemented in such a way that the lighting device and the camera are stationary, while the pulp containers are transported past them on a transport device in a single lane. For the two images, the exposure of the inner wall of the pulp container (with the uniform illumination and the optical pattern) should be approximately identical. For this purpose, the relative position between the mouth of the pulp container and the lighting device, as well as the relative position between the mouth of the pulp container and the camera, should change as little as possible. For typical transport speeds for pulp containers, the pulp container moves less than one millimeter in the specified time and thus a distance which is significantly less than the mouth of the pulp container. This makes it possible to achieve sufficiently equal exposure for both images and thus sufficiently equal conditions for image recording.

It is understood that the method described can be carried out with the apparatus described herein for optically inspecting a pulp bottle.

### BRIEF DESCRIPTION OF THE FIGURES

Further features and advantages are explained below with reference to the exemplary figures in which:

FIG. 1 shows a schematic representation of an apparatus for optically inspecting a pulp bottle according to a first embodiment;

FIG. 2 shows a schematic representation of an apparatus for optically inspecting a pulp bottle according to a second embodiment;

FIG. 3A shows a schematic detailed view of an apparatus for optically inspecting a pulp bottle according to a third embodiment;

FIG. 3B shows a schematic detailed view of an apparatus for optically inspecting a pulp bottle according to a fourth embodiment;

FIG. 4 shows a simplified, schematic plan view of the apparatus according to the third embodiment.

### DETAILED DESCRIPTION

In the following and in the figures, the same reference signs are used for identical or corresponding elements in the various embodiments, unless otherwise specified.

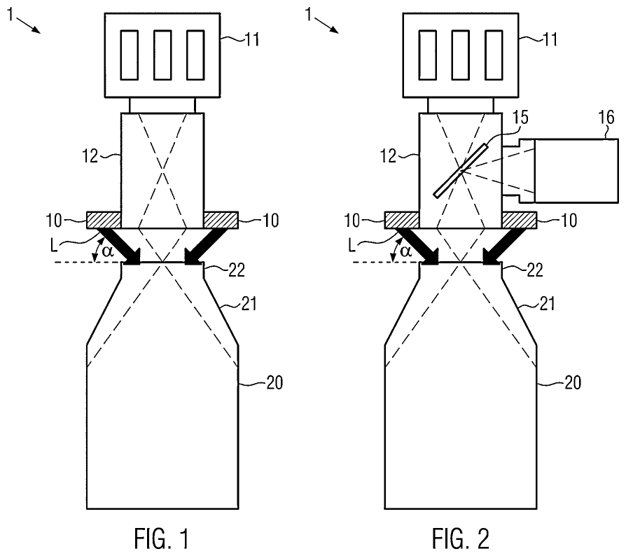

FIG. 1 shows an apparatus 1 for optically inspecting a pulp bottle 20 according to a first embodiment of the disclosure as a schematic side view. The apparatus 1 comprises a lighting device 10 which is configured to emit light L. When a pulp bottle 20 having a bottle neck 21 and a mouth 22 is arranged below the apparatus 1, the light L emitted by the lighting device 10 is irradiated through the mouth 22 into the interior of the pulp bottle. In this way, at least part of the inner wall of the pulp bottle 20 is illuminated. In this case, the light Lis radiated into the mouth at an angle α relative to the mouth plane. The angle α can, for example, be between 60° and 90°, in particular between 70° and 90°. It should be noted that the narrow bottle neck 21, which is characteristic of a bottle, makes it difficult for light L to be coupled into the interior of the pulp bottle 20, unlike, for example, beverage cans. This problem is solved by the described apparatus 1.

The apparatus 1 further comprises a camera 11. The light is scattered on the illuminated part of the inner wall of the pulp bottle 20 and at least partially reflected back through the mouth 22. This reflected light is captured by the camera 11, so that the camera 11 takes/generates an image of the illuminated part of the inner wall of the pulp bottle 20.

In order to image the scattered light onto the camera 11, the apparatus 1 can have a further lens 12 which is arranged in the beam path between the bottle mouth 22 and the camera 11. For this case, the beam path is shown schematically in the figure by the dashed lines. The further lens 12 can, for example, be an inner wall lens having a large depth of field. This has the advantage that the inner wall of the pulp bottle can be sharply imaged over a large region, allowing efficient optical inspection. Alternatively, the camera 11 itself can have a lens so that the further lens 12 is not needed, or the camera 11 and the further lens 12 are considered as a unit.

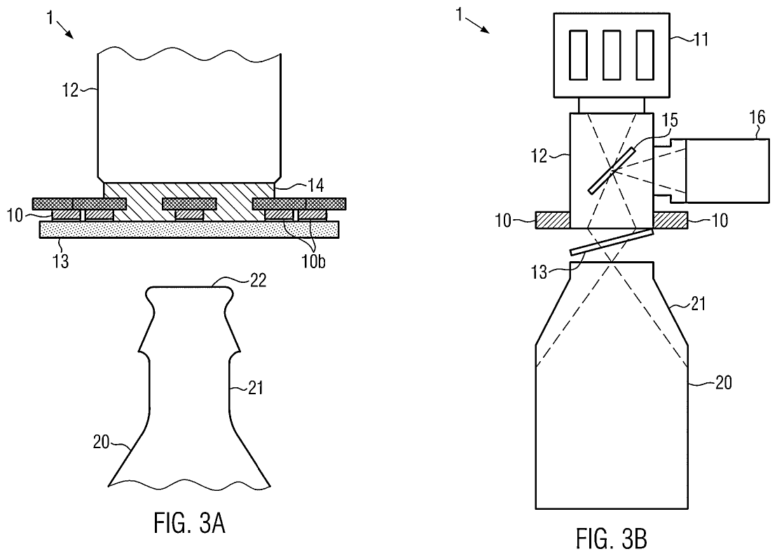

The lighting device 11 has an opening (shown in FIG. 3B). The camera 11 is arranged in this opening. If the apparatus 1 comprises a further lens 12, this further lens 12 is arranged in the opening. If the camera 11 and the further lens 12 are considered as a unit, this unit is arranged in the opening of the lighting device 10. The lighting device 10 can, for example, be ring-shaped or ring-like, so that the camera 11 and/or the further lens 12 is/are partially surrounded. By means of this arrangement above a pulp bottle 20 located below, the greatest possible amount of light L can be radiated into the mouth 22 of the pulp bottle 20, the inner wall can be uniformly illuminated and thus a sufficiently exposed image can be taken for optical inspection.

FIG. 2 shows an apparatus 1 according to the disclosure for optically inspecting a pulp bottle 20 according to a second embodiment. Because the second embodiment largely corresponds to the first embodiment, only the differences between the two embodiments are described here.

First, the apparatus comprises a pattern projector 16 configured to generate and emit an optical pattern. This optical pattern is, for example, a pattern having regular and/or periodic elements, such as a grid or concentric circles. This optical pattern is radiated into the interior of a pulp bottle 20 located under the apparatus 1 and illuminates part of the inner wall. For this purpose, the apparatus 1 further comprises a beam splitter 15 which is arranged such that the light emitted by the pattern projector 16 is reflected by the beam splitter 15 through the mouth 22 of the pulp bottle 20. For this purpose, the beam splitter 15 is arranged between the mouth 22 and the camera 11. The schematic beam path of the optical pattern is also illustrated by dashed lines.

The optical pattern, like the light L emitted by the lighting device 10, is scattered on the inner wall of the pulp bottle 20 and captured by the camera 11 to produce a corresponding image of the inner wall. The imaging process is analogous to the first embodiment.

The beam splitter 15, for example, is a 50:50 beam splitter which reflects 50% of the incident light intensity and transmits 50% of the incident light intensity. In principle, other beam splitters can also be used (e.g. 60:40 or 75:25).

With the second embodiment of the apparatus 1, two images can be taken one after the other. For the first image, the inner wall of the pulp bottle 20 is illuminated as uniformly as possible by the lighting device 10. This serves to identify gross shape defects, darkening contamination and/or holes in the bottom or side wall of the pulp bottle 20. For the second image, the inner wall of the pulp bottle 20 is illuminated with the optical pattern. In this way, thickenings and/or depressions in the bottom or side wall can be detected because the otherwise regular, for example, optical pattern is distorted at the thickenings and/or depressions. The two images together allow a reliable detection of defects in the pulp bottle 20. It goes without saying that the two images can also be taken in reverse order.

The time interval between the two images should be as short as possible, for example less than 100 μs. Typically, the pulp bottles 20 are located on a transport device and are transported under the apparatus 1. In this case, the transport is not stopped for the optical inspection. Between the two images, the pulp bottle 20 thus moves slightly. If the time interval is now short enough, this spatial offset is also small enough, in the range of less than 1 mm, so that neither the illumination of the inner wall of the pulp bottle 20 nor the viewing angle of the camera 11 through the mouth 22 change significantly. This allows the two images to be compared directly without any corrections being necessary.

FIG. 3A shows a third embodiment of an apparatus 1 for optically inspecting a pulp bottle 20. In addition to the components already described (lighting device 10, lens 12 and pulp bottle 20), said apparatus comprises a protective window 13 and a protective element 14.

The protective window 13 is arranged between the lens 12 and the pulp bottle 20. In particular, the protective window 13 is anti-reflective, i.e. it has an anti-reflective coating on its surface in order to keep the proportion of light reflected by the protective window 13 as low as possible. In addition, the protective window 13 serves the purpose of protecting the lens from possible contamination or mechanical impacts. In particular, the lens 12 is not in direct contact with the protective window 13.

The lighting device 10 has a plurality of light sources 10b arranged on the protective window 13. As indicated in the figure, the lighting device 10 is ring-shaped or ring-like and surrounds a lens 12 which is arranged in an opening of the lighting device 10. A protective element 14 is also provided between the light sources 10b and the lens 12. On the one hand, the protective element 13 prevents light from the light sources 10b from falling directly into the lens 12 and thus onto the camera. In addition, the protective element 14 is made in particular of an elastic material, such as foam rubber, so that the lens 12 is protected against possible impacts against the protective window 13. It is understood that the camera 11 can also be attached directly instead of the lens 12. The statements made previously apply equally in this case.

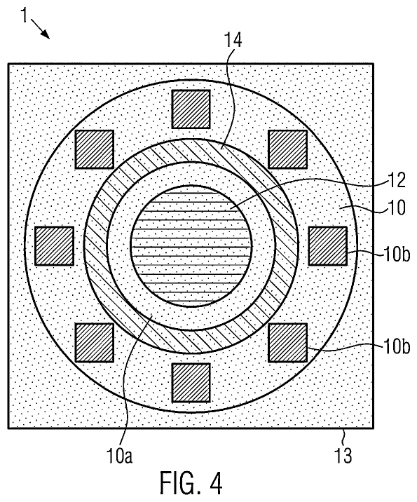

FIG. 3B shows a fourth embodiment of the apparatus 1 for optically inspecting a pulp bottle 20. This differs from the third embodiment shown in FIG. 3A by an alternative arrangement of the protective window 13. This protective window 13 can be inclined relative to the horizontal, for example in a range between 5 degrees and 20 degrees. As a result, light from the lighting device 10 is not reflected in the direction of the camera, but predominantly in the direction of the protective element 14 (not shown in this figure, but visible in FIGS. 3A and 4). The protective element 14 can in particular be black in order to suppress the reflection of light on the protective element 14.

The other elements shown in this figure are already known from the previous explanations and will not be explained again here.

FIG. 4 is a plan view of the apparatus 1 of the third embodiment, wherein the apparatus 1 is seen from below through the protective window 13.

The lighting device 10 comprises a plurality of light sources 10b, for example LEDs, which are arranged on the ring-shaped lighting device 10. The number of light sources 10b shown and their arrangement should by no means be interpreted as restrictive. For example, the light sources 10b can also be what are known as chip-on-board LEDs, which are arranged close together in order to achieve a high luminance.

The (ring-shaped) lighting device 10 has an opening 10a, which in the example shown is circular and concentric with the lighting device 10. As already described with reference to FIG. 3A, the lens 12 is arranged within the opening. The lens is shielded from direct light from the lighting device 10 by the protective element 14.

It is understood that the described embodiments can also be combined with each other in a suitable manner. For example, a pattern projector together with a beam splitter and a protective window can be implemented in a common embodiment. The same considerations also apply to the protective element, which can also be present independently of the protective window.

1. An apparatus for optically inspecting a pulp bottle, comprising:
a lighting device having an opening, wherein a mouth of the pulp bottle can be arranged below the opening of the lighting device; and
a camera which is configured to take an image of at least a part of an inner wall of the pulp bottle through the opening of the lighting device or from the opening of the lighting device,
wherein the pulp bottle can be arranged such that the part of the inner wall of the pulp bottle is illuminated by the lighting device.

2. The apparatus according to claim 1, wherein the camera is arranged in the opening of the lighting device.

3. The apparatus according to claim 1, wherein the lighting device is arranged such that light from the lighting device is irradiated at an angle between 60° and 90° relative to a mouth plane of the pulp bottle.

4. The apparatus according to claim 1, further comprising an anti-reflective protective window,
wherein the lighting device and the camera are arranged on the side of the protective window facing away from the pulp bottle, and
wherein the camera is not in direct contact with the protective window.

5. The apparatus according to claim 1, wherein a protective element made of elastic and opaque material, for example foam rubber, is arranged between the camera and the protective window.

6. The apparatus according to claim 1, wherein the lighting device comprises a plurality of light sources, such as chip-on-board LEDs.

7. The apparatus according to claim 1, further comprising a beam splitter and a light source,
wherein the beam splitter is arranged between the mouth of the pulp bottle and the camera,
wherein the light source is configured as a homogeneous surface illumination and is at least partially faded in by the beam splitter through the mouth into the interior of the pulp bottle.

8. The apparatus according to claim 1, further comprising:
a beam splitter arranged between the mouth of the pulp bottle and the camera; and
a pattern projector configured to generate an optical pattern,
wherein the pattern projector is arranged such that the pattern generated by the pattern projector is partially reflected by the beam splitter through the mouth into the interior of the pulp bottle.

9. The apparatus according to claim 8, wherein the pattern is grid-shaped and/or comprises concentric circles.

10. A system for producing and inspecting pulp bottles, comprising:
an apparatus for producing pulp bottles, and
the apparatus for optically inspecting a pulp bottle according to claim 1,
wherein the system is configured such that the pulp bottles can be transported to the apparatus for optical inspection after production.

11. A method for optically inspecting a pulp container comprising:
illuminating a part of an inner wall of the pulp container through the mouth of said container using a lighting device, and
taking an image through the mouth of the pulp container with a camera by capturing the light scattered from the interior of the pulp container using the camera.

12. The method according to claim 11, wherein light from the illumination device is irradiated at an angle between 60° and 90° relative to a mouth plane of the pulp bottle.

13. The method according to claim 11, further comprising:
illuminating the part of the inner wall of the pulp container with an optical pattern generated, for example, by a pattern projector, and
taking another image by capturing the light scattered from inside the pulp container using the camera.

14. The method according to claim 13, wherein the pattern is grid-shaped and/or comprises concentric circles.

15. The method according to claim 13, wherein the time interval between the taking of the image and the taking of the further image is less than 100 μs, in particular less than 50 μs.

16. The apparatus according to claim 3, wherein the angle is between 70° and 90° relative to the mouth plane of the pulp bottle.

17. The apparatus according to claim 7, wherein an optical element, for example comprising a lens element and/or a polarization filter, is arranged between the beam splitter and the light source.

18. The method according to claim 11, wherein the pulp container is a pulp bottle.

19. The method according to claim 12, wherein the angle is between 70° and 90° relative to the mouth plane of the pulp bottle.
